(19) United States
(12) Patent Application Publication
(10) Pub. No.: US 2009/0070223 A1
(43) Pub. Date: Mar. 12, 2009

(54) System and method for calculating postal charges

(75) Inventors: Dong-Gil Na, Daejeon (KR); Bo Yun Eom, Daejeon (KR); Yong Hoon Choi, Daejeon (KR); Hoon Jung, Daejeon (KR); Jong Heung Park, Daejeon (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/215,402

(22) Filed: Jun. 27, 2008

(30) Foreign Application Priority Data
Sep. 12, 2007 (KR) 10-2007-0092587

(51) Int. Cl. G06Q 50/00

(52) U.S. Cl. 705/14; 705/414

(57) ABSTRACT

A system for calculating postal charges receives detailed information and configuration information about a bulk mail, and collects charge-calculation information on the basis of the detailed information and the configuration information. Then, the system determines discount rates for the bulk mail on the basis of the charge-calculation information, and generates charge information for the mails in consideration of the discount rates. Accordingly, the system for calculating postal charges can provide optimum charges for the mails to a client before the reception of the mails.

### CROSS-REFERENCE TO RELATED APPLICATION

This application claims priority to and the benefit of Korean Patent Application No. 10-2007-0092587 filed in the Korean Intellectual Property Office on Sep. 12, 2007, the entire contents of which are incorporated herein by reference.

### BACKGROUND OF THE INVENTION

(a) Field of the Invention

The present invention relates to a system and method for calculating postal charges. Particularly, the present invention relates to a system and method for calculating optimum charges for a bulk mail.

The present invention was supported by the IT R&D program of MIC/IITA [2006-X-001-02, Development of Element Technology for Real-time Postal Distribution].

(b) Description of the Related Art

In general, a technique for changing the number of sample matters is used to calculate charges for a bulk mail, which are requested to be sent by a provider for sending bills or promotional materials, in post offices or distribution centers. The technique for charging the number of sample matters includes randomly selecting a sample from the bulk mail, calculating the weight for the sample, calculating the gross weight, and calculating the number of all the bulk mails by dividing the gross weight by the sample weight, and calculating the entire charges by multiplying the charges by the number of all the mails.

When the charges are calculated by using the technique as described above, errors occur in the number of the bulk mails due to changes of the environment, such as temperature and humidity. For this reason, there is a problem in that the errors have an effect on the charge calculation.

Further, when the charges are calculated by using the technique, the bulk mail should be put into different transport containers on the basis of the weight thereof in order to be received. For this reason, there are problems in that the number of the transport containers to be used is increased and time for the reception of the mails is also increased.

Furthermore, if a bulk mail is received in a post office immediately before its closing time, it is not possible to know the number of bulk mail and information about the time when the mails are received in advance. For this reason, there are problems in that work burden is increased on a counter of the post office and a process for treating the mails and clients' waiting time is increased.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a system and method for calculating optimum charges for a bulk mail.

Further, the present invention has been made in an effort to simply and quickly receive bulk mail and pay charges for the mails, thereby reducing time required for the reception of the mails and improving working efficiency of a post office.

According to an embodiment of the present invention, a method of calculating postal charges includes receiving detailed information about a bulk mail and configuration information corresponding to the detailed information before the reception of the bulk mail, collecting charge-calculation information on the basis of the detailed information and the configuration information, determining discount rates for the bulk mail on the basis of the charge-calculation information, and generating charge information about the bulk mail on the basis of the discount rates.

The collecting of the charge-calculation information may include collecting postal charge/rate information corresponding to weight groups, calculating the weight of each of the mails on the basis of the detailed information in order to generate weight information, and generating the charge-calculation information that includes the detailed information, the configuration information, the postal charge/rate information, and the weight information.

Further, each of the discount rates may include a classification discount rate and a volume discount rate. Furthermore, the determining of the discount rates may include determining volume discount rates for the bulk mail on the basis of the detailed information, and determining classification discount rates for the bulk mail on the basis of the configuration information and the weight information.

The determining of the classification discount rates may include classifying the bulk mail into a plurality of weight groups on the basis of the weight information, and determining a classification discount rate for each of the weight groups on the basis of the configuration information.

The generating of the charge information may include applying the volume discount rate and the classification discount rate for each of the weight groups to postal charge/rates corresponding to the postal charge/rate information, calculating charges for each of the weight groups, and generating the charge information.

According to another embodiment of the present invention, a method of calculating postal charges includes receiving component information about weight of components that are included in a bulk mail, and configuration information about the bulk mail, generating weight information about weight of each of the mails on the basis of the component information, classifying the bulk mail into a plurality of weight groups on the basis of the weight information, and calculating charges for each of the weight groups on the basis of the configuration information.

In the classifying of the mails, the bulk mails may be classified into the plurality of weight groups by using a simulated annealing algorithm.

The calculating of the charges may include determining a discount rate corresponding to a mail belonging to one weight group among the plurality of weight groups, and calculating charges for the weight groups in consideration of the discount rate.

The method may further include collecting postal charge/rate information corresponding to the weight groups. In the calculating of the charges for the weight groups, charges for the weight group may be calculated by applying the discount rate to a postal charge/rate for a weight group, which corresponds to an average weight of the weight group, on the basis of the postal charge/rate information.

According to still another embodiment of the present invention, a system for calculating postal charges includes a receiving interface and a calculation server. The receiving interface generates and transmits a detailed post information file including detailed information for each of the mails and post configuration information corresponding to the detailed information in order to receive a bulk mail. The calculation server receives the detailed post information file, determines discount rates for the mails on the basis of the detailed post information file and the post configuration information, and generates charge information about the mails.

The receiving interface may include a post information input unit and a post information transmitting unit. The post information input unit receives the detailed information including information about the number of the mails, identification bar code information of the mails, zip code information thereof, receiving office designation information thereof, receiving type information thereof, and component information thereof, and generates the detailed post information files, analyzes the detailed post information files, and generates the post configuration information including the configuration of the detailed information and information about the presence of components. The post information transmitting unit transmits the detailed post information files and the post configuration information to the calculation server.

The calculation server may include a post information receiving unit and a postal charge calculating unit. The post information receiving unit receives the detailed post information files and the post configuration information. The postal charge calculating unit determines a volume discount rate on the basis of the detailed post information files, determines a classification discount rate on the basis of the configuration information, and generates the charge information in consideration of the volume discount rate and the classification discount rate.

The postal charge calculating unit may include an information collector and a charge calculator. The information collector collects postal charge/rate information corresponding to weight groups, and generates weight information about the weight of each of the mails on the basis of the detailed post information files. The charge calculator determines the volume discount rates on the basis of the detailed post information files, classifies the bulk mail into a plurality of weight groups on the basis of the weight information and the configuration information in order to determine a classification discount rate for each of the weight groups, and generates the charge information by applying the volume discount rate and the classification discount rate to a postal charge/rate corresponding to the postal charge/rate information.

The charge calculator may include a volume discount rate calculating module, a weight group classifying module, and a classification discount rate calculating module. The volume discount rate calculating module determines the volume discount rate on the basis of the volume information included in the detailed post information files. The weight group classifying module classifies the bulk mail into the plurality of weight groups on the basis of the weight information by using a simulated annealing algorithm. The classification discount rate calculating module determines a classification discount rate for each of the weight groups on the basis of the classification information.

According to the embodiments of the present invention, post information is received and charges are calculated before the reception of mails, so that it is possible to provide optimum charges to a client and to confirm the number of mails in advance. Therefore, the work burden on a process for treating the mails is decreased in a post office. As a result, it is possible to reduce clients' waiting time.

### BRIEF DESCRIPTION OF THE DRAWINGS

FIG. 1 is a view showing the configuration of a system for calculating postal charges according to an exemplary embodiment of the present invention.

FIG. 2 is a view showing the configuration of a post information input unit according to the exemplary embodiment of the present invention.

FIG. 3 is a view showing the configuration of a postal charge calculating unit according to the exemplary embodiment of the present invention.

FIG. 4 is a flowchart illustrating a method of calculating postal charges according to another exemplary embodiment of the present invention.

FIG. 5 is a flowchart illustrating an algorithm that is executed to classify weight groups according to another exemplary embodiment of the present invention.

FIG. 6 is a view illustrating a workflow using the system for calculating postal charges according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, the term “includes” on “comprises” means that the referred-to constituent element is present, but other constituent elements may further be present as long as it is not described to the contrary. Further, each of terms such as “unit”, “device”, and “module” described in the specification means a unit for performing at least one function or operation, and may be embodied by hardware, software, or a combination of hardware and software.

A system and method for calculating postal charges according to exemplary embodiments of the present invention will be described below with reference to the accompanying drawings.

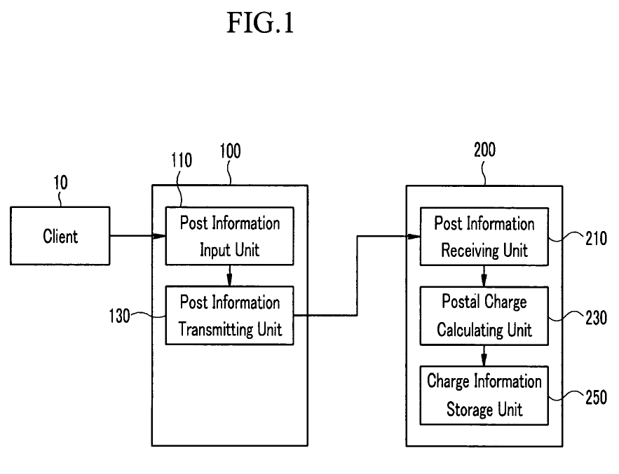

First, a system for calculating postal charges according to an exemplary embodiment of the present invention will be described with reference to FIG. 1.

FIG. 1 is a view showing the configuration of the system for calculating postal charges according to an exemplary embodiment of the present invention.

As shown in FIG. 1, the system for calculating postal charges includes a receiving interface 100 and a calculation server 200.

The receiving interface 100 is an interface that receives post information from a client 10, and includes a post information input unit 110 and a post information transmitting unit 130.

The post information input unit 110 of the receiving interface 100 receives detailed information about a mail from the client 10, and generates a detailed post information file and post configuration information corresponding to the detailed post information file on the basis of the detailed information.

The post information transmitting unit 130 of the receiving interface 100 transmits the detailed post information file and the post configuration information, which are generated by the post information input unit 110, to the calculation server 200. In this case, the post information transmitting unit 130 may transmit the detailed post information file to the calculation server 200 through the Internet.

The calculation server 200 is a server that is formed by a postal service provider and calculates postal charges. The calculation server includes a post information receiving unit 210, a postal charge calculating unit 230, and a charge information storage unit 250.

The post information receiving unit 210 of the calculation server 200 receives the detailed post information file and the post configuration information from the receiving interface 100. The post information receiving unit 210 may receive detailed post information files that include detailed information about a bulk mail.

The postal charge calculating unit 230 of the calculation server 200 receives detailed information about mails from the post information receiving unit 210, calculates postal charges on the basis of the detailed information about the mails, and generates charge information.

The charge information storage unit 250 of the calculation server 200 stores the charge information that is generated by the postal charge calculating unit 230.

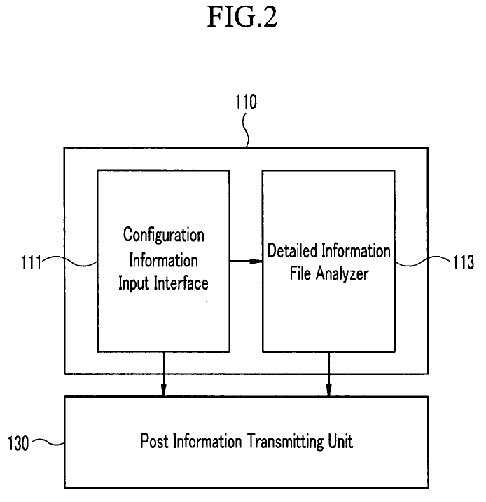

The post information input unit of the receiving interface according to the exemplary embodiment of the present invention will be described below with reference to FIG. 2.

FIG. 2 is a view showing the configuration of the post information input unit according to the exemplary embodiment of the present invention.

As shown in FIG. 2, the post information input unit 110 includes a configuration information input interface 111 and a detailed information file analyzer 113.

The configuration information input interface 111 receives detailed information about mails, such as the number of mails, identification bar codes thereof, zip codes thereof, the designation of receiving offices thereof, receiving types thereof, and component information thereof, from the client 10. Then, the configuration information input interface generates detailed post information files including the detailed information. The component information includes, for example, names, types, and weight of the components of the mails. In this case, the configuration information input interface 111 receives the detailed information about the bulk mail, and may generate the detailed post information files of the bulk mail.

The detailed information file analyzer 113 analyzes the detailed post information files generated by the configuration information input interface 111, and generates post configuration information. The post configuration information may include the configuration of the detailed information about the mails and information about the presence of components.

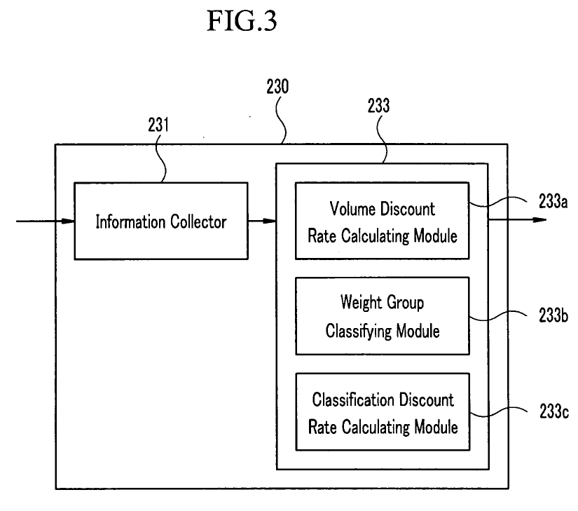

The postal charge calculating unit of the calculation server according to the exemplary embodiment of the present invention will be described below with reference to FIG. 3.

FIG. 3 is a view showing the configuration of the postal charge calculating unit according to the exemplary embodiment of the present invention.

As shown in FIG. 3, the postal charge calculating unit 230 includes an information collector 231 and a charge calculator 233.

The information collector 231 collects charge-calculation information. The charge-calculation information may include the detailed information of the mails, post configuration information, postal charge/rate information, and the weight of the mails. The information collector 231 receives the detailed information of the mails and post configuration information from the post information receiving unit 210, collects postal charge/rate information on the basis of predetermined postal charges/rates, and can calculate the weight of the mail by using the detailed information of the mails. In this case, the information collector 231 may sum up the weight of the components by using the detailed information in order to calculate the weight of the mails. Further, the information collector 231 may calculate the weight of each of the mails in order to generate weight information.

The charge calculator 233 calculates the postal charges on the basis of the charge-calculation information collected by the information collector 231. The charge calculator 233 can calculate the postal charges for the bulk mail. When the bulk mail meets discount conditions, the charge calculator 233 may calculate postal charges in consideration of discount rates. In this case, the charge calculator 233 includes a volume discount rate calculating module 233a, a weight group classifying module 233b, and a classification discount rate calculating module 233c.

The volume discount rate calculating module 233a of the charge calculator 233 determines volume discount rates corresponding to the number of mails.

The weight group classifying module 233b of the charge calculator 233 classifies the bulk mail into a plurality of groups on the basis of the weight information.

The classification discount rate calculating module 233c of the charge calculator 233 determines classification discount rates in consideration of the discount corresponding to bar code printing that is provided by the postal service provider on the basis of the post configuration information, the discount corresponding to zip code classification, the discount corresponding to receiving offices, the discount corresponding to receiving types, and the like. In this case, the discount corresponding to the receiving types may include a pallet receipt by each distribution center.

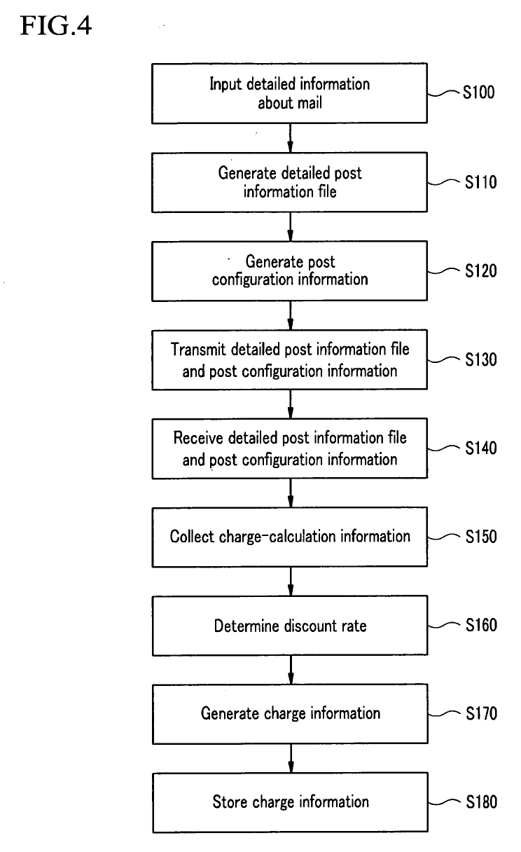

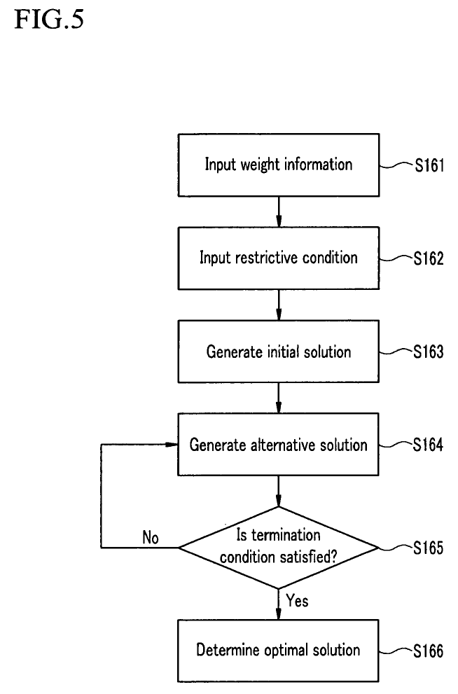

A method of calculating postal charges according to another exemplary embodiment of the present invention will be described below with reference to FIG. 4 and 5.

FIG. 4 is a flowchart illustrating a method of calculating postal charges according to another exemplary embodiment of the present invention.

As shown in FIG. 4, the client 10 inputs the detailed information about the bulk mail through the configuration information input interface 111 (S100).

Then, the configuration information input interface 111 generates detailed post information files including the detailed information about the mails that are input by the client 10 (S110).

Subsequently, the detailed information file analyzer 113 analyzes the detailed post information files, and generates post configuration information about the plurality of mails (S120).

After that, the post information transmitting unit 130 transmits the detailed post information files and the post configuration information to the calculation server 200 (S130).

Then, the post information receiving unit 210 receives the detailed post information files and the post configuration information from the receiving interface 100 (S140).

Subsequently, the information collector 231 collects charge-calculation information (S150). In this case, the charge-calculation information may include detailed information about the mails, the post configuration information, weight information, and postal charge/rate information.

After that, the charge calculator 233 determines the discount rates of the charges of the bulk mail on the basis of postal charge-calculation information (S160). Each of the discount rates may include a classification discount rate and a volume discount rate. In this case, the volume discount rate calculating module 233a of the charge calculator 233 may determine the volume discount rates of the bulk mail on the basis of the number of mails that are included in the detailed information of the mails. Further, the weight group classifying module 233b of the charge calculator 233 classifies the bulk mail into a plurality of weight groups on the basis of the weight information, and the classification discount rate calculating module 233c of the charge calculator 233 may determine the classification discount rate for each of the weight groups. Furthermore, the weight group classifying module 233b may classify the bulk mail into a plurality of weight groups by optimal solutions, which are obtained by a simulated annealing algorithm, in order to obtain optimum charges.

The algorithm executed by the weight group classifying module according to the current exemplary embodiment of the present invention will be described below with reference to FIG. 5.

FIG. 5 is a flowchart illustrating the algorithm executed to classify weight groups according to the current exemplary embodiment of the present invention.

As shown in FIG. 5, the weight group classifying module 233b inputs weight information about the bulk mail (S161).

Then, the weight group classifying module 233b inputs restrictive conditions in order to execute an algorithm (S162). In this case, the weight group classifying module 233b may input restrictive conditions, such as initial temperature, termination conditions, and the number of repetitions. Further, the restrictive conditions may be predetermined.

Subsequently, the weight group classifying module 233b gives different group numbers to the plurality of predetermined weight groups, and generates initial solutions (S163).

One of the methods for obtaining initial solutions includes: 1) arranging the bulk mail in order of weight groups and giving a sequence number to each weight group; 2) selecting the lightest (or the heaviest) weight group; 3) determining whether a selected weight group and a neighboring weight group can be put into one group; 4) if possible, grouping the selected weight group and the neighboring weight group as one group (i.e., the same sequence number is given); 5) moving to the next weight group that has not been grouped, and repeating 1) to 5) to the last weight group in order to finish one initial solution.

For example, sequence numbers 1, 2, 3, 4, and 5 are given to weight groups 20g, 21g, 22g, 23g, and 24g of each mail. The lightest weight group (i.e., weight group of 20g) is selected and determined whether the selected weight group can be grouped into the weight group of 21g. If the grouping is possible, the weight group grouped into the weight group of 21g is given the same sequence number as of the weight group of 21g and then the sequence numbers are rearranged. Accordingly, the sequence numbers of the weight groups are changed to 1, 1, 2, 3, and 4. Next, the weight group of 22g is selected and determined whether the weight group of 22g can be grouped into the weight group of 23g. If the grouping is possible, the sequence numbers are rearranged to 1, 1, 2, 2, and 3. Then, the weight group of 24g is selected. In this case, however, the selected weight group does not have a neighboring group to be selected for grouping, and therefore the grouping process is finished and the initial solution (1, 1, 2, 2, and 3) is obtained and charges of the obtained initial solutions are calculated.

After that, the weight group classifying module 233b generates alternative solutions by the simulated annealing algorithm (S164).

One of the methods for generating alternative solutions includes selecting a group into which more than two weight groups are grouped from the initial solution, separating the selected group and determining whether the separated group can be grouped into its neighboring weight group. If the grouping is possible, the corresponding weight groups are grouped into one group. In the case that the alternative solutions are smaller than the initial solutions, the alternative solutions are stored.

For example, the weight group of 23g in group 2 is selected from the obtained initial solutions 1, 1, 2, 2, and 3, and is determined whether it can be grouped into the weigh group of 24g. If the grouping is possible, the sequence numbers are rearranged and alternative solutions (i.e., 1, 1, 2, 3, and 3) are generated. Then, charges of the alternative solutions are calculated, and the alternative solutions are stored as optimal solutions if the calculated charges are smaller than the charges of the initial solutions.

Then, the weight group classifying module 233b judges whether the alternative solutions satisfy the termination conditions (S165). If the alternative solutions satisfy the termination conditions, the weight group classifying module 233b determines the alternative solutions as the optimal solutions (S166).

The smallest value among the alternative solutions stored in the step of S164 is determined as the optimal solution.

Meanwhile, if the alternative solutions do not satisfy the termination condition, the weight group classifying module 233b performs Step S164 again.

The method of calculating postal charges according to the current exemplary embodiment of the present invention will be further described with reference to FIG. 4.

After the Step S160, the charge calculator 233 calculates charges for each of the weight groups, and generates charge information about the bulk mail (S170). The charge calculator 233 applies the classification discount rates and the volume discount rates to the postal charge/rates that correspond to the average weight of the bulk mail belonging to corresponding weight groups, and calculates the charges for corresponding weight groups. In this case, the charge information may include charges for each of the weight groups.

Then, the charge information storage unit 250 stores the charge information (S180).

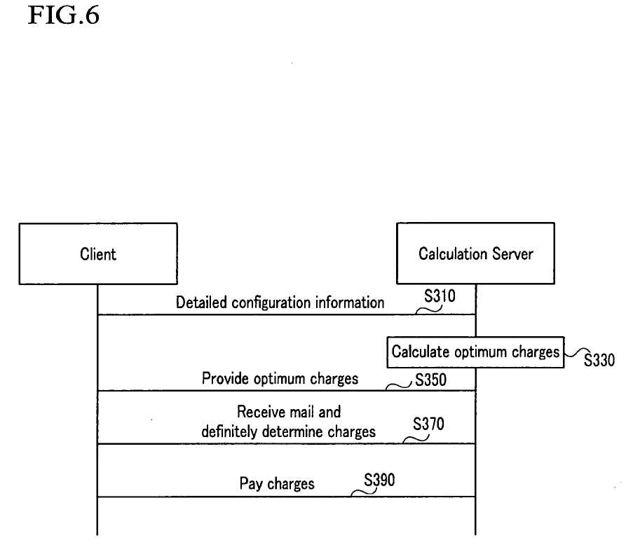

A workflow using the system for calculating postal charges according to the exemplary embodiment of the present invention will be described below with reference to FIG. 6.

FIG. 6 is a view illustrating the workflow using the system for calculating postal charges according to the exemplary embodiment of the present invention.

As shown in FIG. 6, the client 10 provides post information about a bulk mail, which is intended to be sent, to the calculation server 200 through the receiving interface 100 (S310). In this case, the configuration information input interface 111 of the receiving interface 100 registers the detailed information files of a client's computer system, and transmits the files to the calculation server 200. Therefore, the configuration information input interface can provide post information to the calculation server 200.

Then, the calculation server 200 calculates optimum charges for the bulk mail on the basis of the post information (S330).

After that, the calculation server 200 provides the optimum charges for the bulk mail, which is intended to be sent by the client 10, to the client 10 (S350).

Then, when the client 10 registers a bulk mail, the calculation server 200 determines definite charges for the bulk mail after checking whether the number of mails corresponds to the post information (S370).

Subsequently, the client 10 pays the definitely determined charges (S390). In this case, the client 10 may pay the charges by a deferred payment method.

The above-mentioned exemplary embodiments of the present invention are not only embodied by a method and apparatus, but they may be embodied by a program performing functions that correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of calculating postal charges, the method comprising:
receiving detailed information about a bulk mail and configuration information corresponding to the detailed information before the reception of the bulk mail;
collecting charge-calculation information on the basis of the detailed information and the configuration information;
determining discount rates for the bulk mail on the basis of the charge-calculation information; and
generating charge information about the bulk mail on the basis of the discount rates.

2. The method of claim 1,
wherein the collecting of the charge-calculation information includes:
collecting postal charge/rate information corresponding to weight groups;
calculating the weight of each of the mails on the basis of the detailed information in order to generate weight information; and
generating the charge-calculation information that includes the detailed information, the configuration information, the postal charge/rate information, and the weight information.

3. The method of claim 2,
wherein each of the discount rates includes a classification discount rate and a volume discount rate, and
the determining of the discount rates includes:
determining volume discount rates for the bulk mail on the basis of the detailed information; and
determining classification discount rates for the bulk mail on the basis of the configuration information and the weight information.

4. The method of claim 3,
wherein the determining of the classification discount rates includes:
classifying the bulk mail into a plurality of weight groups on the basis of the weight information; and
determining a classification discount rate for each of the weight groups on the basis of the configuration information.

5. The method of claim 4,
wherein the generating of the charge information includes:
applying the volume discount rate and the classification discount rate for each of the weight groups to postal charge/rates corresponding to the postal charge/rate information;
calculating charges for each of the weight groups; and
generating the charge information.

6. A method of calculating postal charges, the method comprising:
receiving component information about weight of components that are included in a bulk mail, and configuration information about the bulk mail;
generating weight information about weight of each of the mails on the basis of the component information;
classifying the bulk mail into a plurality of weight groups on the basis of the weight information; and
calculating charges for each of the weight groups on the basis of the configuration information.

7. The method of claim 6, wherein, in the classifying of the mails, lo the bulk mail is classified into the plurality of weight groups by using a simulated annealing algorithm.

8. The method of claim 7,
wherein the calculating of the charges includes:
determining a discount rate corresponding to the classification of a mail belonging to one weight group among the plurality of weight groups; and
calculating charges for the weight groups in consideration of the discount rate.

9. The method of claim 8, further comprising
collecting postal charge/rate information corresponding to the weight groups,
wherein, in the calculating of the charges for the weight groups, charges for the weight group are calculated by applying the discount rate to a postal charge/rate for a weight group, which corresponds to an average weight of the weight group, on the basis of the postal charge/rate information.

10. A system for calculating postal charges, the system comprising:
a receiving interface that generates and transmits a detailed post information file including detailed information for each of a bulk mail and post configuration information corresponding to the detailed information in order to receive the bulk mail; and
a calculation server that receives the detailed post information file, determines discount rates for the mails on the basis of the detailed post information file and the post configuration information, and generates charge information about the mails.

11. The system of claim 10,
wherein the receiving interface includes:
a post information input unit that receives the detailed information including information about the number of mails, identification bar code information of the mails, zip code information thereof, receiving office designation information thereof, receiving type information thereof, and component information thereof, and generates the detailed post information files, analyzes the detailed post information files, and generates the post configuration information including the configuration of the detailed information and information about the presence of components; and
a post information transmitting unit that transmits the detailed post information files and the post configuration information to the calculation server.

12. The system of claim 10,
wherein the calculation server includes:
a post information receiving unit that receives the detailed post information files and the post configuration information; and
a postal charge calculating unit that determines a volume discount rate on the basis of the detailed post information files, determines a classification discount rate on the basis of the configuration information, and generates the charge information in consideration of the volume discount rate and the classification discount rate.

13. The system of claim 12,
wherein the postal charge calculating unit includes:
an information collector that collects postal charge/rate information corresponding to weight groups, and generates weight information about the weight of each of the mails on the basis of the detailed post information files; and
a charge calculator that determines the volume discount rates on the basis of the detailed post information files, classifies the bulk mail into a plurality of weight groups on the basis of the weight information and the configuration information in order to determine a classification discount rate for each of the weight groups, and generates the charge information by applying the volume discount rate and the classification discount rate to a postal charge/rate corresponding to the postal charge/rate information.

14. The system of claim 13,
wherein the charge calculator includes:
a volume discount rate calculating module that determines the volume discount rate on the basis of the volume information included in the detailed post information files;
a weight group classifying module that classifies the bulk mail into the plurality of weight groups on the basis of the weight information by using a simulated annealing algorithm; and
a classification discount rate calculating module that determines a classification discount rate for each of the weight groups.
